(19) United States
(12) Patent Application Publication
(10) Pub. No.: US 2004/0267469 A1
(43) Pub. Date: Dec. 30, 2004

(54) On-die waveform capture

(75) Inventors: Bryan K. Casper, Hillsboro, OR (US); Aaron K. Martin, Hillsboro, OR (US); James E. Jaussi, Hillsboro, OR (US); Stephen R. Mooney, Beaverton, OR (US)

Correspondence Address: LeMoine Patent Services, c/o PortfolioIP, P.O. Box 52050, Minneapolis, MN, 55402, US

(73) Assignee: Intel Corporation

(21) Appl. No.: 10/603,374

(22) Filed: Jun. 25, 2003

(51) Int. Cl. G06F 19/00

(52) U.S. Cl. 702/66

(57) ABSTRACT

A port circuit includes circuitry to capture a waveform. The port circuit may be a unidirectional port circuit, or a bidirectional port circuit.

### FIELD

The present invention relates generally to testing of circuits, and more specifically to the measurement of signal waveforms.

### BACKGROUND

Within electronic systems, integrated circuits communicate with each other using electrical signals that travel through electrical conductors. During testing of electronic systems, electrical conductors are typically probed with test equipment to verify that electrical signals exhibit desired characteristics. For example, signal characteristics such as voltage amplitude and time delay may be measured using test equipment.

Test equipment probes typically have an effect on electrical signals when conductors are probed. For example, capacitive effects of a probe may distort the signal when the probe is placed upon an electrical conductor through which the signal travels. This can result in measurement errors, in part because the signal is being distorted by the test equipment attempting to measure it.

As the size of electronic systems decrease, and as the speeds with which they operate increase, the signal distorting effects of test equipment can become more pronounced.

For the reasons stated above, and for other reasons stated below which will become apparent to those skilled in the art upon reading and understanding the present specification, there is a need in the art for alternate mechanisms for measuring signals.

### BRIEF DESCRIPTION OF THE DRAWINGS

FIG. 1 shows a diagram of two integrated circuits;

FIG. 2 shows a captured waveform;

FIG. 3 shows a flowchart in accordance with various embodiments of the present invention;

FIG. 4 shows a diagram of an integrated circuit;

FIG. 5 shows a diagram of a port circuit;

FIG. 6 shows a diagram of a simultaneous bidirectional port circuit;

FIG. 7 shows a schematic of a sampler; and

FIGS. 8 and 9 show system diagrams in accordance with various embodiments of the present invention.

### DESCRIPTION OF THE EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

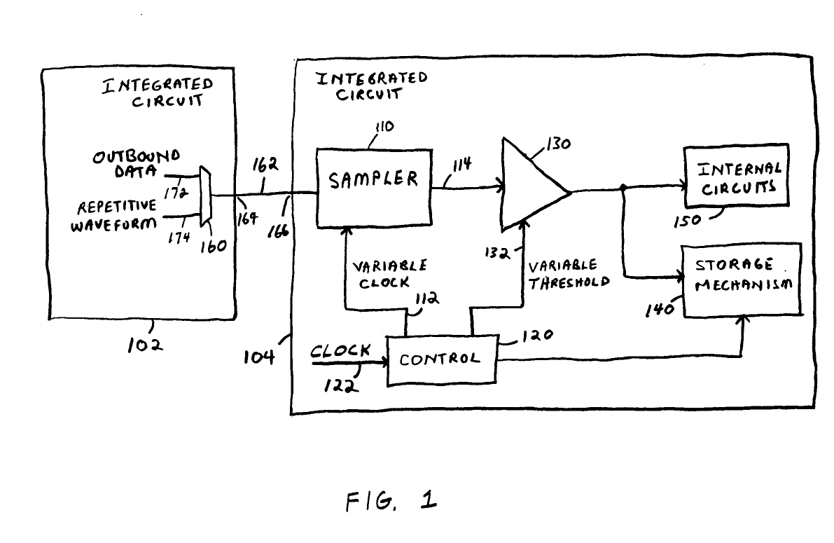

FIG. 1 shows a diagram of two integrated circuits 102 and 104. In operation, integrated circuit 102 sources a waveform on output node 164, which travels through conductor 162, and is received by integrated circuit 104 at input node 166. Integrated circuit 102 includes multiplexer 160 to select a data source from either outbound data on node 172, or a repetitive waveform on node 174. The outbound data on node 172 is sourced by other circuits (not shown) in integrated circuit 102, and represents data to be transferred between integrated circuits during normal operation. For example, multiplexer 160 may select outbound data from a register file, an arithmetic logic unit (ALU), a memory device, or any other functional block within integrated circuit 102. The repetitive waveform is selected by multiplexer 160 to provide a repetitive waveform on conductor 162 to be captured, in whole or in part, by integrated circuit 104.

Integrated circuit 104 includes sampler 110, receiver 130, internal circuits 150, storage mechanism 140, and control mechanism 120. Sampler 110 samples the waveform received on input node 166 in response to the variable clock signal sourced by control mechanism 120. Sampler 110 provides the waveform sample to receiver 130 on node 114. Receiver 130 compares the amplitude of the waveform sample on node 114 to the variable threshold on node 132, and provides a digital output to either or both of internal circuits 150 or storage mechanism 140. Internal circuits 150 represent any circuitry within integrated circuit 104 that receives data from receiver 130 during normal operation. For example, internal circuits 150 may include registers, memory, graphics devices, or any other functional blocks within integrated circuit 104. Storage mechanism 140 is used to store information related to “waveform-capture” mode, which is described below.

Receiver 130 may be one of many different types. For example, in some embodiments, receiver 130 includes an amplifier with a single-ended input to receive the waveform sample on node 114, and a reference voltage input to receive a reference voltage on node 132. In other embodiments, receiver 130 includes a variable offset comparator with a differential input to receive a differential input signal on node 114. In these embodiments, node 114 includes two conductors to carry a differential signal. The variable threshold on node 132 may be a reference voltage to be compared against the waveform sample on node 114, or may be a control signal that specifies a threshold or reference to be used within receiver 130. For example, in some embodiments, the variable threshold on node 132 includes a digital word that specifies an offset to be utilized within a variable offset comparator that has a differential input.

Control mechanism 120 provides a variable clock signal to sampler 110 and a variable threshold to receiver 130. Control mechanism 120 can be any type of circuit capable of providing the variable clock and variable threshold, and capable of communicating with storage mechanism 140. For example, control mechanism 120 may include a microprocessor, a state machine, or the like. Control mechanism 120 may also include a voltage reference circuit. In some embodiments, control mechanism 120 includes a memory-mapped interface to allow an external device to access the capabilities of control mechanism 120. For example, embodiments that include a memory-mapped interface may allow an external device to control the variable clock and the variable reference sourced by control mechanism 120. Also for example, embodiments that include a memory-mapped interface may also allow an external device to retrieve information from storage mechanism 140.

Each of integrated circuits 102 and 104 can operate in one of two modes: an “operational” mode, and a “waveform-capture” mode. In operational mode, integrated circuit 102 sources data onto conductor 162 from outbound data node 172. This data, as described above, may be from any source within integrated circuit 102. Also in operational mode, sampler 110 samples the signal waveform on conductor 162 at the appropriate time and presents the waveform sample to receiver 130. Receiver 130 converts the waveform sample to digital data, and the digital data is sent on to internal circuits 150.

In operational mode, control mechanism 120 sources a clock signal that allows sampler 110 to sample the incoming waveform at a time point that provides adequate timing margin. For example, for a four gigabit per second (4 Gb/s) data link, sampler 110 samples every 250 picoseconds (ps), near the center of each bit cell. Also in operational mode, control mechanism 120 sources a threshold value to receiver 130 that provides adequate timing margin. Control mechanism 120 may use information gathered in waveform-capture mode (described below) to determine the appropriate threshold value for operational mode.

In waveform-capture mode, integrated circuit 102 provides a repetitive waveform on conductor 162, and integrated circuit 104 repeatedly samples the waveform at various times and compares it to various thresholds to “capture” the waveform. The repetitive data provided by integrated circuit 102 can be any repeating data stream, such that integrated circuit 104 can sample the “same” time point of the waveform relative to a fixed point in the repeating pattern. For example, the repetitive data may be produced by a linear feedback shift register (LFSR), a state machine, a shift register preloaded with data of interest, or the like.

In some embodiments, a LFSR is configured to produce a repetitive pattern every 80 bits. In other embodiments, shorter or longer patterns are used. During waveform-capture mode, the waveform that is captured corresponds to a portion of the repeating waveform, or the entire repeating waveform.

Control mechanism 120 provides a variable clock to sampler 110 on node 112 to allow sampler 110 to vary the time at which a sample is taken. In some embodiments, the variable clock can be varied over at least one bit cell period. For example, for a four gigabit per second (4 Gb/s) data link, the variable clock may be varied over at least 250 picoseconds (ps). In some embodiments, the variable clock signal can be varied with approximately 9 ps resolution, but the present invention is not limited in this respect.

Control mechanism 120 also provides a variable threshold to receiver 130 on node 132. Receiver 130 produces a digital signal that is the result of an amplitude comparison between the sampled waveform on node 114 and the variable threshold on node 132. Accordingly, the variable threshold causes receiver 130 to change the received signal level below which a digital “0” is output, and above which a digital “1” is output.

By varying the variable clock and the variable threshold in a coordinated fashion, control mechanism 120 can cause the “capture” of all or part of the repetitive waveform received on input node 166. For each time point in a repetitive waveform, control mechanism 120 varies the threshold to take multiple measurements of the same point in the repeating waveform. An example waveform is shown in the following figure.

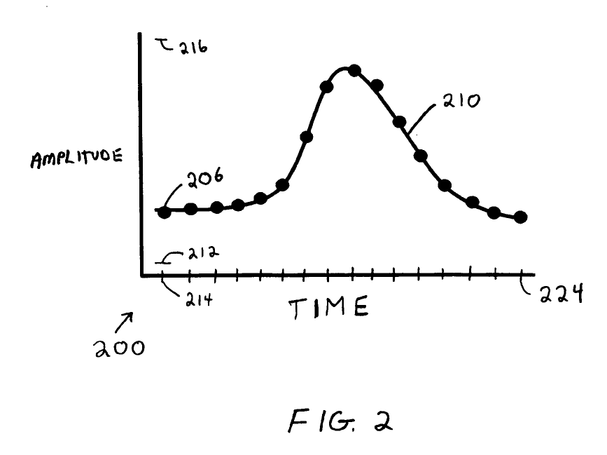

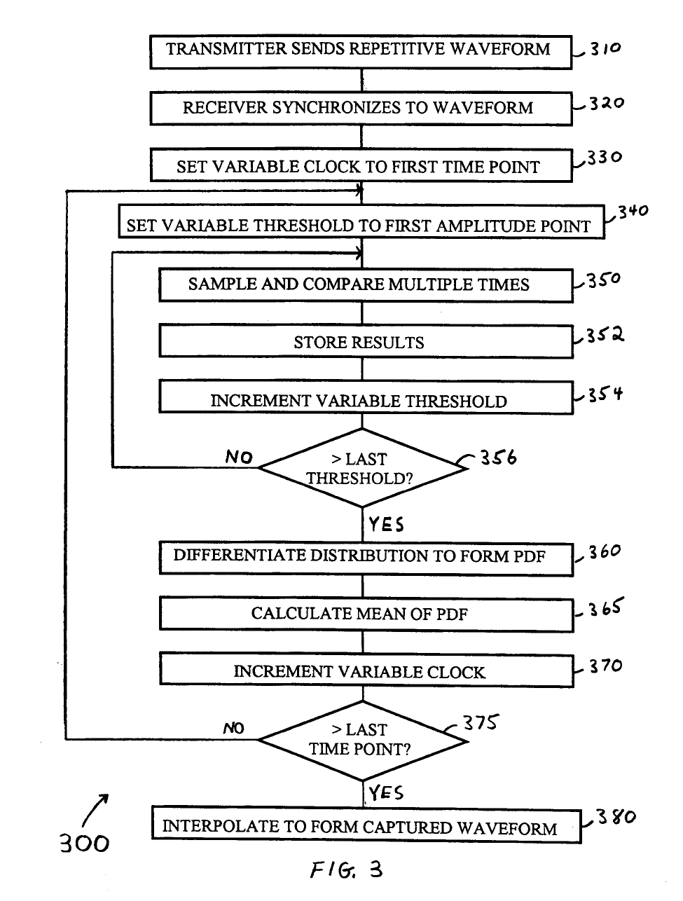

FIG. 2 shows a captured waveform. Waveform 200 corresponds to a portion of a repeating waveform. For example, waveform 200 may correspond to a 135 ps section of a repeating waveform on conductor 162 (FIG. 1) sampled at 9 ps intervals. Waveform 200 may be captured using method 300, which is shown in FIG. 3. Method 300 and waveform 200 are described together in the following paragraphs.

In block 310 of method 300, a transmitter sends a periodic and repeatable waveform. This corresponds to integrated circuit 102 sending the repetitive waveform on conductor 162 (FIG. 1). In block 320, a receiver synchronizes to the repeating waveform such that time points within the waveform can be repeatedly sampled. This corresponds to control mechanism 120 receiving the clock signal on node 122 (FIG. 1). This may also correspond to a clock recovery loop circuit (not shown) to generate a clock signal.

In block 330, the variable clock is set to sample the repetitive waveform at the first time point of interest. In FIG. 2, this time point refers to time 214. In block 340, the variable threshold is set to a first value corresponding to amplitude 212 shown in FIG. 2. In block 350, the repeating waveform is sampled a number of times at the current time point, and the waveform sample is compared against the current threshold to produce a digital “0” or a digital “1”. In block 352, the number of digital “1”s or the number of digital “0”s output by receiver 130 is stored in storage mechanism 140.

In block 354, the threshold is incremented, and the actions in blocks 350 and 352 are repeated for the new threshold. Block 356 tests the threshold level, and blocks 350, 352, and 354 are repeated until the threshold has been incremented to the last point of interest, shown in FIG. 2 as amplitude 216.

When the threshold is initialized at a low amplitude, it is more likely that the receiver will output a digital “1” than a digital “0” because the amplitude of the waveform is clearly above the threshold. Likewise, when the threshold is at a high amplitude, it is more likely that the receiver will output a digital “0” than a digital “1” because the amplitude of the waveform is clearly below the threshold. As the threshold is increased towards the amplitude of the waveform from below, the likelihood increases that the receiver will output a digital “0” rather than a digital “1”. This likelihood information is stored as a “distribution” in storage mechanism 140 after the actions in blocks 340, 350, 352, and 354 are performed for a given time point.

In block 360 of method 300, the distribution stored in storage mechanism 140 is differentiated to create a probability density function (pdf) of the uncertainty in the waveform. This uncertainty can be caused by many different factors, including but not limited to, jitter, voltage noise, or noise present in receiver 130.

In block 365, the mean of the pdf for each time point is calculated to determine the most likely amplitude position of the waveform at each time point. The mean of the pdf for the first time point 214 is shown at 206.

In block 370, the variable clock is incremented, and the actions in blocks 350 and 352 are repeated for the new threshold. Block 375 tests the time point, and blocks 340, 350, 352, 354, 356, 360, 365, and 370 are repeated until the clock has been incremented to the last time point of interest, shown in FIG. 2 as time point 224. This corresponds to sampling the waveform multiple times for each threshold at each time point shown in FIG. 2, storing the likelihood information for each threshold, creating the pdf for the time point, and calculating the mean of the pdf.

The captured waveform may then be reconstructed in block 380 by interpolating between the means at each time point. In FIG. 2, the captured waveform is shown at 210.

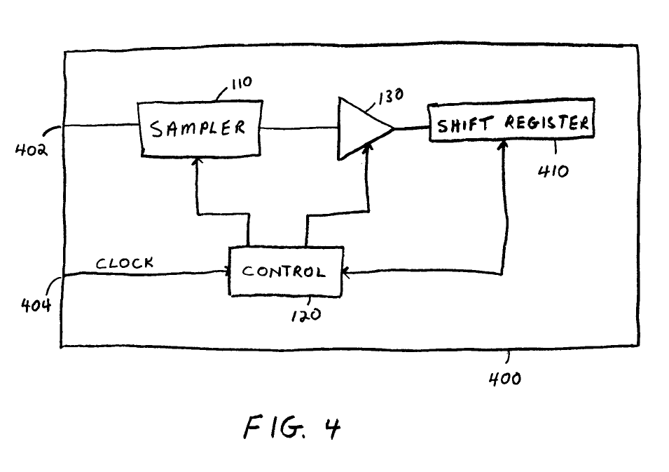

FIG. 4 shows a diagram of an integrated circuit. Integrated circuit 400 includes sampler 110, receiver 130, control mechanism 120, and shift register 410. In embodiments represented by FIG. 4, shift register 410 serves as at least a portion of storage mechanism 140 (FIG. 1). Sampler 110, receiver 130, control mechanism 120, and shift register 410 are part of a port circuit within integrated circuit 400. In some embodiments, integrated circuit 400 includes many port circuits. Port circuits may be used to receive signals one-by-one, or port circuits may be grouped to communicate with busses external to integrated circuit 400.

Sampler 110 receives a signal to be sampled on input node 402, and control mechanism 120 receives a clock signal on node 404. In some embodiments, the signal to be sampled and the clock signal are sourced by the same integrated circuit. For example, integrated circuit 102 may source both a signal to be sampled and a clock signal to integrated circuit 104 (FIG. 1).

In some embodiments, shift register 410 captures every result from receiver 130. For example, each time control mechanism 120 causes sampler 110 to sample an incoming waveform, control mechanism 120 may also command shift register 410 to capture the digital output of receiver 130. In these embodiments, when an 80 bit long repeating pattern is used, shift register 410 captures one sample at the current time point for each bit in the 80 bit long repeating pattern. As the time point is incremented (see FIG. 3), the whole waveform is captured. In other embodiments, the clock is gated so that only a portion of the waveform is captured. For example, when an 80 bit long repeating pattern is received by integrated circuit 400, control mechanism 120 may provide a clock transition to sampler 110 or shift register 410 at the current time point for only one of the 80 bits. In these embodiments, as the time point is incremented, a portion of the waveform is captured.

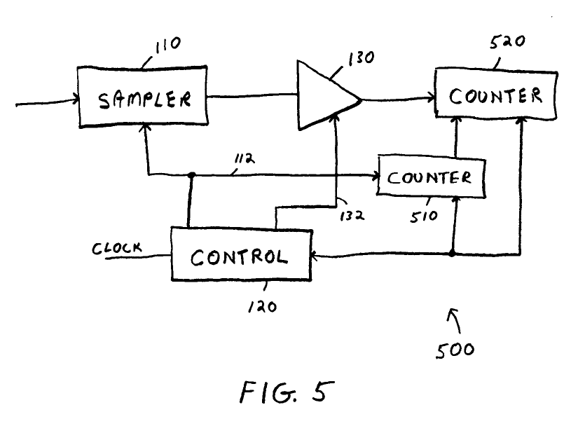

FIG. 5 shows a diagram of a port circuit. Port circuit 500 includes counter circuits 510 and 520 as a portion of storage mechanism 140 (FIG. 1). Counter circuit 510 may count clock transitions provided to sampler 110 by control mechanism 120, and counter circuit 520 may count either the number of digital “1s” or digital “0s” produced by receiver 130. Control mechanism 120 may read information from counter circuit 520 as part of the actions in the various blocks listed in method 300 (FIG. 3).

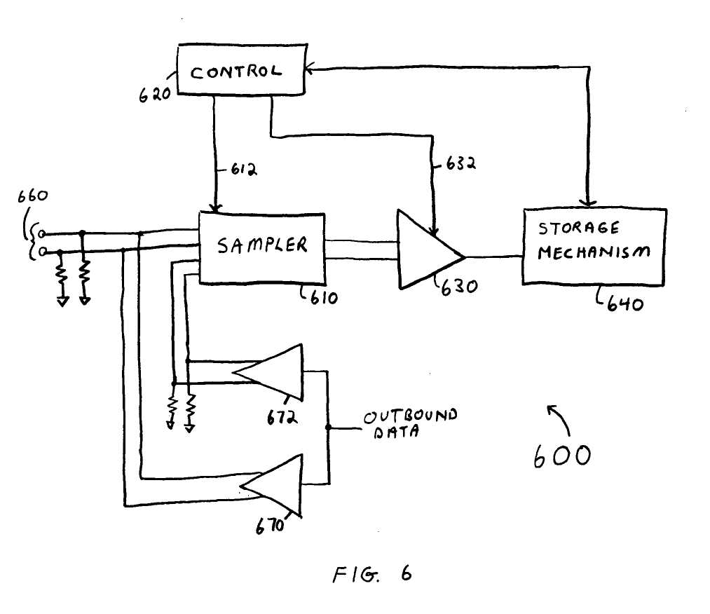

FIG. 6 shows a diagram of a simultaneous bidirectional port circuit. Simultaneous bidirectional port circuit 600 includes output driver 670, replica driver 672, sampler 610, receiver 630, control mechanism 620, and storage mechanism 640. Output driver 670 drives data onto conductors 660, and receiver 630 receives data from conductors 660. Another simultaneous bidirectional port circuit (not shown) can be coupled to drive data on conductors 660 in the same manner as simultaneous bidirectional port circuit 600.

Conductors 660 represent a simultaneous bidirectional signal node. When two simultaneous bidirectional port circuits are configured to drive data on conductors 660, the voltages on the conductors are the sum of the voltages representing data from both simultaneous bidirectional data ports. Replica driver 672 drives sampler 610 with a replica of the output data driven by output driver 670. Replica driver 672 may have the same drive strength as output driver 670, or may have a different drive strength. In some embodiments, output driver 670 and replica driver 672 are current mode differential drivers, and replica driver 672 has a lower drive strength to conserve power. The load resistors on the various conductors may be adjusted in value to compensate for the different drive strengths.

Sampler 610 samples the voltages on the simultaneous bidirectional node as well as the output of replica driver 672. In embodiments represented by FIG. 6, sampler 610 provides receiver 630 with a waveform sample that represents the waveform transmitted by the other simultaneous bidirectional port circuit (not shown) by subtracting the effects of the voltage driven by replica driver 672. Receiver 630 can be implemented using a variable offset comparator that receives variable threshold information on node 632, and varies an offset in response.

Simultaneous bidirectional port circuit 600 can capture a waveform, or a portion of a waveform transmitted by another simultaneous bidirectional data port circuit (not shown) on conductors 660. Control mechanism can sweep a variable clock on node 612, and can sweep a variable offset on node 632 to capture a waveform. For example, simultaneous bidirectional port circuit 600 may implement method 300 (FIG. 3) or a similar method. Also for example, an integrated circuit that includes simultaneous bidirectional port circuit 600 may implement method 300 (FIG. 3) or a similar method.

In some embodiments, simultaneous bidirectional port circuit 600 includes the ability to source a repetitive waveform on the outbound data, similar to that shown in integrated circuit 102 (FIG. 1). When each simultaneous bidirectional data port circuit coupled to a common conductor includes the ability to source a repetitive waveform and capture a repetitive waveform, waveforms from each output driver can be captured, and testing of the interfaces can be greatly simplified.

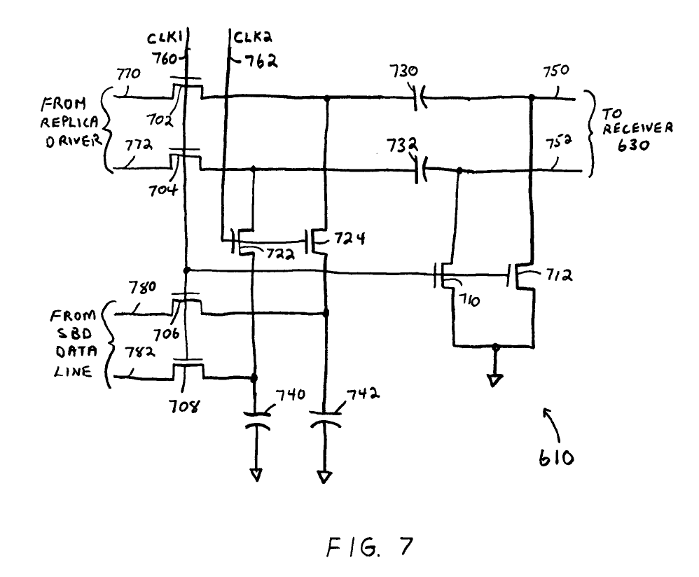

FIG. 7 shows a schematic of a sampler. Sampler 600 includes sampling capacitors 740, 742, 730, and 732, and pass transistors 702, 704, 706, 708, 722, 724, 710, and 712. Sampler 600 includes input nodes 770 and 772 which are coupled to the output nodes of replica driver 672 (FIG. 6), and input nodes 780 and 782 which are coupled to the simultaneous bidirectional data line shown as conductors 660 in FIG. 6. Sampler 610 also includes output nodes 750 and 752 which are coupled to the input nodes of receiver 630 (FIG. 6).

Sampler 610 receives a two-phase clock signal on nodes 760 and 762. During one phase of the clock, CLK1 is high, and CLK2 is low. During this phase, sampling capacitors 740 and 742 sample the voltages on the simultaneous bidirectional data line, and sampling capacitors 710 and 712 sample the voltages on the output of the replica driver. During the second phase of the clock, CLK1 is low which isolates the sampling capacitors from the input nodes, and CLK2 is high which connects the sampling capacitors in series to subtract the outbound voltage from the line voltage, leaving the input of the comparator with only the inbound voltage.

The transistors shown in FIG. 7 are shown as isolated gate transistors, and specifically as metal oxide semiconductor field effect transistors (MOSFETs). For example, transistors 702 and 704 are shown as N-type MOSFETs. Other types of switching or amplifying elements may be utilized for the various transistors of sampler 610 without departing from the scope of the present invention. For example, the transistors of sampler 610 may be junction field effect transistors (JFETs), bipolar junction transistors (BJTs), or any device capable of performing as described herein.

Port circuits, samplers, control mechanisms, receivers, storage mechanisms, simultaneous bidirectional port circuits and other embodiments of the present invention can be implemented in many ways. In some embodiments, they are implemented in integrated circuits as part of data busses. In some embodiments, design descriptions of the various embodiments of the present invention are included in libraries that enable designers to include them in custom or semi-custom designs. For example, any of the disclosed embodiments can be implemented in a synthesizable hardware design language, such as VHDL or Verilog, and distributed to designers for inclusion in standard cell designs, gate arrays, or the like. Likewise, any embodiment of the present invention can also be represented as a hard macro targeted to a specific manufacturing process. For example, simultaneous bidirectional port circuit 600 (FIG. 6) can be represented as polygons assigned to layers of an integrated circuit.

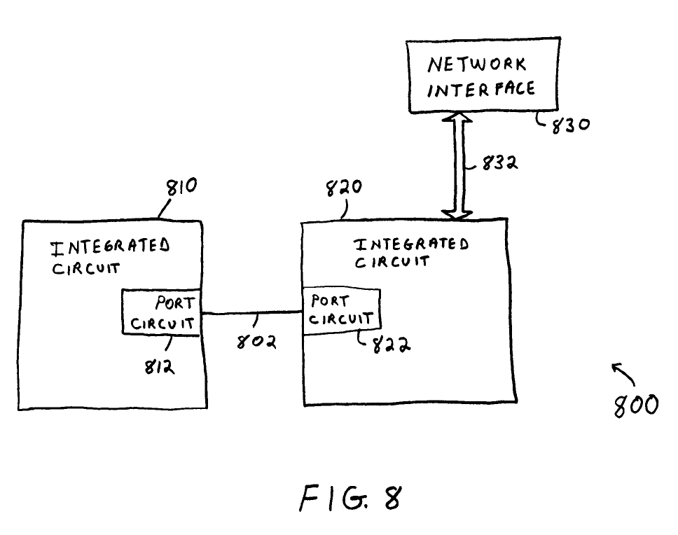

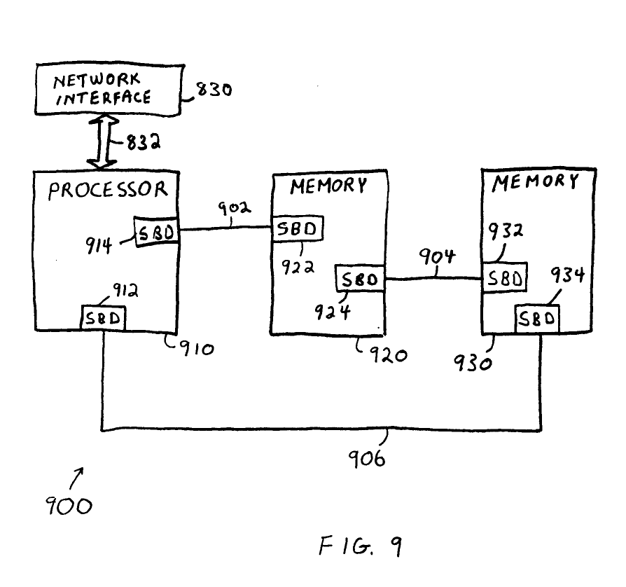

FIGS. 8 and 9 show system diagrams in accordance with various embodiments of the present invention. FIG. 8 shows system 800 including integrated circuits 810 and 820, and network interface 830. Integrated circuit 810 includes port circuit 812, and integrated circuit 820 includes port circuit 822. As shown in FIG. 8, the port circuits communicate using conductor 802. In some embodiments, port circuits 812 and 822 are simultaneous bidirectional data (SBD) port circuits that drive data onto, and receive data from, conductor 802. In these embodiments, conductor 802 serves as a simultaneous bidirectional signal node. Conductor 802 may include one or more physical conductors. For example, port circuits 812 and 822 may be differential SBD circuits similar to that shown in FIG. 6, and conductor 802 may include two physical conductors to carry a differential signal. In some embodiments, one or more of port circuits 812 and 822 can be implemented with one of the previously described port circuits that includes waveform capture capabilities.

Integrated circuits 810 and 820 can be any type of integrated circuit capable of including one or more port circuits as shown. For example, either integrated circuit 810 or 820 can be a processor such as a microprocessor, a digital signal processor, a microcontroller, or the like. Either integrated circuit can also be an integrated circuit other than a processor such as an application-specific integrated circuit (ASIC), a communications device, a memory controller, or a memory such as a dynamic random access memory (DRAM). For ease of illustration, portions of integrated circuits 810 and 820 are not shown. The integrated circuits may include much more circuitry than illustrated in FIG. 8 without departing from the scope of the present invention.

Integrated circuits 810 and 820 are shown in FIG. 8 having a single port circuit each. In some embodiments, each integrated circuit may have many more port circuits. For example, in some embodiments, entire data busses are driven by banks of port circuits. In other embodiments, nodes for control signals or groups of nodes for control signals are driven by port circuits.

Network interface 830 communicates with integrated circuit 820 over bus 832. In some embodiments, network interface 830 also communicates with integrated circuit 810 and other integrated circuits (not shown). For example, in some embodiments, network interface 830 is a card such as a peripheral component interconnect (PCI) card that communicates with other integrated circuits on a system board. In other embodiments, network 830 is an integrated circuit tightly coupled to integrated circuit 820. Network interface 830 may be any type of network interface that allows system 800 to communicate on a network. For example, network interface may allow connection to a wireless network, a wired network, or the like.

FIG. 9 shows electronic system 900 including processor 910, memories 920 and 930, and network interface 830. Processor 910 includes SBD port circuits 912 and 914, memory 920 includes SBD port circuits 922 and 924, and memory 930 includes SBD port circuits 932 and 934. One or more of the SBD port circuits shown in FIG. 9 may include SBD circuitry with waveform capture abilities, such as simultaneous bidirectional data port circuit 600 (FIG. 6).

Processor 910, memory 920, and memory 930 are configured in a ring such that each device communicates with two others using at least one SBD port circuit coupled to a simultaneous bidirectional signal node. For example, processor 910 communicates with memory 920 using SBD port circuit 914 coupled to simultaneous bidirectional signal node 902, and also communicates with memory 930 using SBD port circuit 912 coupled to simultaneous bidirectional signal node 906. Also for example, memory device 920 communicates with memory device 930 using SBD port circuit 924 coupled to simultaneous bidirectional signal node 904.

Processor 910 and memory devices 920 and 930 are shown in FIG. 9 having two SBD port circuits each. In some embodiments, each device may have many more SBD port circuits. For example, in some embodiments, entire data busses are driven by banks of SBD port circuits. In other embodiments, nodes for control signals or groups of nodes for control signals are driven by SBD port circuits.

In some embodiments, processor 910 is part of one integrated circuit die, memory device 920 is part of a second integrated circuit die, and memory device 930 is part of a third integrated circuit die. In these embodiments, each of the integrated circuit dice may be separately packaged and mounted on a common circuit board. Each of the integrated circuits may also be separately packaged and mounted on separate circuit boards interconnected by the simultaneous bidirectional signal nodes. In other embodiments, processor 910 and memory devices 920 and 930 are separate integrated circuit dice packaged together, such as in a multi-chip module.

FIG. 9 shows one processor and two memory devices. In some embodiments, many more memory devices are included. Further, any number of processors can be included. In other embodiments, circuit types other than processors and memory devices are included in system 900.

Network interface 830 is coupled to processor 910 by bus 832. In some embodiments, network interface 830 includes an SBD port with waveform capture capabilities. In these embodiments, network interface 830 may capture waveforms sent by processor 910 across bus 832. In other embodiments, network interface 830 includes SBD port circuits without waveform capture, and in still other embodiments, network interface 830 communicates with processor 910 with port circuits other than simultaneous bidirectional port circuits.

Systems represented by the various foregoing figures can be of any type. Examples of represented systems include computers (e.g., desktops, laptops, handhelds, servers, tablets, web appliances, routers, etc.), wireless communications devices (e.g., cellular phones, cordless phones, pagers, personal digital assistants, etc.), computer-related peripherals (e.g., printers, scanners, monitors, etc.), entertainment devices (e.g., televisions, radios, stereos, tape and compact disc players, video cassette recorders, camcorders, digital cameras, MP3 (Motion Picture Experts Group, Audio Layer 3) players, video games, watches, etc.), and the like.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A simultaneous bidirectional port circuit comprising:
a sampling circuit configured to sample an incoming waveform;
a receiver coupled to the sampling circuit configured to measure an amplitude of the incoming waveform;
a storage mechanism to store information from the receiver; and
a control mechanism configured to control the receiver and the sampling circuit to measure the amplitude of a repetitive incoming waveform at a plurality of time points.

2. The simultaneous bidirectional port circuit of claim 1 wherein the receiver comprises a variable offset comparator.

3. The simultaneous bidirectional port circuit of claim 1 wherein the storage mechanism comprises a counter.

4. The simultaneous bidirectional port circuit of claim 1 wherein the storage mechanism comprises a shift register.

5. The simultaneous bidirectional port circuit of claim 1 further comprising an output driver having an output node coupled to an input node of the sampling circuit.

6. The simultaneous bidirectional port circuit of claim 1 wherein:
the receiver comprises a comparator; and
the simultaneous bidirectional port circuit further comprises a variable reference coupled to the comparator.

7. The simultaneous bidirectional port circuit of claim 1 wherein the control mechanism is configured to calculate a distribution for each of the plurality of time points.

8. An integrated circuit comprising:
a signal node to receive a data signal; and
a port circuit coupled to the signal node, the port circuit configured to receive digital data from the signal node during a first mode of operation, and configured to capture a waveform of a signal on the signal node during a second mode of operation.

9. The integrated circuit of claim 8 wherein the port circuit comprises a variable offset comparator having an input node coupled to the signal node.

10. The integrated circuit of claim 8 wherein the port circuit comprises an output driver having an output coupled to the signal node.

11. The integrated circuit of claim 10 wherein the port circuit is configured as a simultaneous bidirectional port circuit.

12. The integrated circuit of claim 8 further comprising a clock input node to receive a clock signal.

13. The integrated circuit of claim 12 wherein the port circuit further comprises a sampling circuit coupled to the clock input node to sample the signal on the signal node at various time points.

14. The integrated circuit of claim 13 further comprising a storage mechanism to store information describing the waveform of the signal.

15. The integrated circuit of claim 14 wherein the storage mechanism comprises a counter.

16. The integrated circuit of claim 14 wherein the storage mechanism comprises a shift register.

17. An electronic system comprising:
an integrated circuit including a signal node to receive a signal, and a port circuit coupled to the signal node, the port circuit configured to receive digital data from the signal node during a first mode of operation, and configured to capture a waveform of the signal on the signal node during a second mode of operation; and
a network interface capable of coupling the integrated circuit to a network.

18. The electronic system of claim 17 wherein the port circuit comprises a variable offset comparator having an input node coupled to the signal node.

19. The electronic system of claim 17 wherein the port circuit comprises an output driver having an output coupled to the signal node.

20. The electronic system of claim 17 wherein the port circuit comprises a sampling circuit to sample the signal on the signal node at various time points.

21. A method of capturing a waveform on an integrated circuit die comprising:
sampling a simultaneous bidirectional data signal at a first time point;
receiving the simultaneous bidirectional data signal at a receiver; and
varying a threshold of the receiver.

22. The method of claim 21 wherein sampling comprises subtracting an outgoing signal from an incoming signal.

23. The method of claim 21 wherein receiving comprises receiving the simultaneous bidirectional data signal at a variable offset comparator.

24. The method of claim 23 wherein varying a threshold comprises varying an offset of the variable offset comparator.

25. The method of claim 24 further comprising:
sampling the simultaneous bidirectional data signal at a plurality of time points; and
varying the offset of the variable offset comparator at each of the plurality of time points.

26. The method of claim 21 wherein the simultaneous bidirectional data signal is repetitive, and sampling at a first time point comprises taking a plurality of samples at substantially the same time with respect to the repetitive signal.

27. The method of claim 26 further comprising varying the threshold during the plurality of samples.

28. A method comprising:
receiving a signal at a receiver configured to receive digital data and configured to capture a waveform of the signal;
sampling the signal at a plurality of time points; and
varying a threshold of the receiver at each of the plurality of time points.

29. The method of claim 28 wherein the signal is repetitive, and wherein sampling comprises sampling the repetitive signal more than once at each of the plurality of time points.

30. The method of claim 29 wherein:
receiving comprises receiving the signal at a variable offset comparator; and
varying a threshold of the receiver comprises varying an offset of the variable offset comparator.
